(19) United States
(12) Patent Application Publication
(10) Pub. No.: US 2009/0306956 A1
(43) Pub. Date: Dec. 10, 2009

(54) INFORMATION PROCESSING APPARATUS, METHOD, PROGRAM AND RECORDING MEDIUM THEREOF

(75) Inventors: Kazuyoshi Takahashi, Tokyo (JP); Yoshiro Miyoshi, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/481,168

(22) Filed: Jun. 9, 2009

(30) Foreign Application Priority Data
Jun. 10, 2008 (JP) 2008-151684

(51) Int. Cl. G06F 9/455; G06F 3/00

(52) U.S. Cl. 703/24; 715/700

(57) ABSTRACT

An information processing apparatus includes: a display control means for controlling display of a GUI for operating a first apparatus including buttons operated when opening and closing a tray; and a processing means for performing processing by receiving an instruction from the first apparatus or for transmitting the instruction to the first apparatus, wherein the GUI includes graphics of a second apparatus obtained by copying out the first apparatus, and the second apparatus includes graphics corresponding to the tray and the button, when the button in the second apparatus is operated, the display control means controls graphics in which the tray is opened or closed in the second apparatus, and when the button provided in the first apparatus is operated, the processing means instructs the display control means to control graphics in which the tray is opened or closed in the second apparatus.

### BACKGROUND OF THE INVENTION

1. Field of the Invention

The invention relates to an information processing apparatus, a method, a program and a recording medium thereof, particularly, relates to an information processing apparatus, a method, a program and a recording medium thereof which is suitable to be used for evaluating data to be recorded in a given recording medium without recording the data in the recording medium in fact.

2. Description of the Related Art

As various discs standardized as discs in which a blue-violet laser diode (hereinafter written as “BD”) of 405 nm is used as a light source and large volumes of video, music, character data and the like can be recorded, for example, there are a rewritable-disc standard “BD-RE”, a playback only-disc standard “BD-ROM”, a recordable-disc standard “BD-R”, a DVD (digital Versatile Disc) and the like. Particularly among them, the standards of “BD-RE” and “BD-ROM” are known as discs which can record programs of HDTV (high-definition television) broadcast for more than two hours on one surface of the disc.

There is an apparatus called as an edit data evaluation apparatus (hereinafter, written as an emulator) which can verify operations of edit data to be recorded in the BD-ROM and the like. The emulator is an apparatus which emulates actual reading conditions and the like of a disc by a disc drive. The emulator is used in authoring, which is a test tool used in an authoring studio for checking whether data is operated correctly in a player or a recorder (hereinafter, written as a recording/playback apparatus) at a point before actually making the disc when the contents of the disc such as the BD-ROM are created.

Specifically, the emulator is an apparatus in which a hard disc drive (hereinafter, written as “HDD”) is connected instead of using a disc drive as a recording/playback apparatus, and disc image data of the BD-ROM on the HDD is recorded and played back as if the recording/playback apparatus read the BD-ROM.

The actual recording/playback apparatus accesses the disc, however, the emulator is adapted to access data recorded in the HDD instead of accessing the disc (for example, refer to JP-A-2006-285861 (Patent Document 1). According to the emulator adapted as described above, it is possible to verify operations such as a transfer rate, access time and the like which is edited data.

FIG. 1 is a diagram showing a configuration of one example of an emulator in related art. An emulator 11 is connected to an HDD 12 and a monitor 13. The emulator 11 includes an emulator control unit 21, a recording/playback apparatus 22 and a drive 23. However, the drive 23 is connected by being re-connected after the connection with respect to the HDD 12 is released.

The emulator 11 reads disc image data stored in the HDD 12 and writes disc image data into the HDD 12. Video which can be obtained by processing disc image data read from the HDD 12 is supplied to the monitor 13.

The recording/playback apparatus 22 of the emulator 11 is, for example, a commercially available player and the drive 23 is a drive provided in the player. As described above, the emulator 11 is adapted to access the HDD 12 instead of accessing the drive 23, therefore, the drive 23 has a configuration of being connected according to need, which is not usually connected. The connection between the recording/playback apparatus 22 and the emulator control unit 21 indicates that the emulator control unit 21 operates as the disc drive when seen from the recording/playback apparatus 22 side.

As the recording/playback apparatus 22, an apparatus equivalent to the commercially available player is used. Therefore, the apparatus can be operated by operation buttons provided in a body of the recording/playback apparatus 22, an attached remote controller and the like. In the ordinary recording/playback apparatus 22 (commercially available player), the received operation is, for example, for reading data from a recording medium set in the drive 23, however, in the case of the emulator 11, the operation is for reading data from the HDD 12. The operation is performed on the emulator 11 side in a state in which the difference is not realized by the user.

Accordingly, the user can operate the emulator 11 with the feeling that the user operates the ordinary player. The emulator 11 transmits disc image data stored in the HDD 12 back to the recording/playback apparatus 22 in response to an ATAPI command issued by the recording/playback apparatus 22, performing operation as if the emulator played back the disc. The recording/playback apparatus 22 converts playback data transmitted from the emulator control unit 21 into a video signal or an audio signal, outputting the signal to the monitor 13. The user verifies whether the image in the disc is correctly created by checking video played back on the monitor 13.

As described above, the user performs playback of a disc image instead of the disc by the emulator 11, thereby checking playback operation when the operation button or the remote controller is operated, for example, playback operation of a menu and the like is performed following the plan at the time of editing.

### SUMMARY OF THE INVENTION

As described above, the emulator 11 performs processing of a disc image stored in the HDD 12 instead of data which will be recorded in a disc to be set in the drive 23. Since the user does not actually perform an operation of setting the disc in the drive 23, it is sometimes difficult to recognize to which disc the data processed by the user will be recorded.

An example of a screen accessed by the user when performing operation with respect to the emulator 11 is shown in FIG. 2. The screen shown in FIG. 2 is displayed on a monitor (not shown) on which screens for operations are displayed when the emulator 11 is performed. The screen shown in FIG. 2 is the screen when designating a disc image to be edited.

As shown in FIG. 2, a window 41 is opened on the monitor, and a column 42 and a button 43 are provided in the window 41. In the column 42, a path in which the disc image is stored is inputted by the user. The button 43 is operated when the disc image stored in the path destination inputted in the column 42 is processed. The processing of the disc image is processing of verifying whether normal operations can be performed in the disc image or not. That is, the processing is to verify data to be edited, therefore, the button 43 of “start verification of edit data” is provided in the screen example shown in FIG. 2.

As described above, the path of the disc image to be verified have to be inputted. When verifying plural disc images, not one disc image, it is necessary to input paths of respective disc images. It is sometimes difficult to recognize which path corresponds to which disc image. Accordingly, there is a case in which verification efficiency is reduced, as a result, usability of the emulator is reduced.

Thus, it is desirable to save the trouble concerning verification of disc images.

An information processing apparatus according to an embodiment of the invention includes a display control means for controlling display of a GUI for operating a first apparatus including buttons operated when opening and closing a tray and a processing means for performing processing by receiving an instruction from the first apparatus or for transmitting the instruction to the first apparatus, in which the GUI includes graphics of a second apparatus obtained by copying out the first apparatus, and the second apparatus includes graphics corresponding to the tray and the button, in which, when the button in the second apparatus is operated, the display control means controls graphics in which the tray is opened or closed in the second apparatus, and in which, when the button provided in the first apparatus is operated, the processing means instructs the display control means to control graphics in which the tray is opened or closed in the second apparatus.

When plural first apparatuses exist, the display control means controls display so that plural second apparatuses respectively corresponding to the first apparatuses are displayed on the GUI.

A storage device is connected to the first apparatus, and disc image data is stored in the storage device, the GUI includes graphics obtained by copying out a disc associated with the disc image data. When the graphics obtained by copying out the disc is dragged and dropped onto the second apparatus, the display control means controls graphics from a state in which the tray of the second apparatus is opened to a state in which the disc is set on the opened tray. The processing means can instruct the first apparatus to play back the disc image data associated with the graphics obtained by copying out the disc which has been dragged and dropped.

The storage device can also include a storage device connected through a network.

When the first apparatus is newly connected to a network, the display control means can generate graphics of the second apparatus corresponding to the first apparatus which has been newly connected and can display the graphics on the GUI.

An information processing method according to another embodiment of the invention includes the steps of controlling a GUI for operating a first apparatus including buttons operated when opening and closing a tray, performing processing by receiving an instruction from the first apparatus, or transmitting the instruction to the first apparatus, including graphics of a second apparatus obtained by copying out the first apparatus in the GUI, and including graphics corresponding to the tray and the button in the second apparatus, controlling graphics in which the tray is opened or closed in the second apparatus when the button of the second apparatus is operated, and controlling graphics in which the tray is opened or closed in second apparatus when the button provided in the first apparatus is operated.

A program according to still another embodiment of the invention is a program readable by a computer which executes processing including the steps of controlling a GUI for operating a first apparatus including buttons operated when opening and closing a tray, performing processing by receiving an instruction from the first apparatus, or transmitting the instruction to the first apparatus, including graphics of a second apparatus obtained by copying out the first apparatus in the GUI, and including graphics corresponding to the tray and the button in the second apparatus, controlling graphics in which the tray is opened or closed in the second apparatus when the button of the second apparatus is operated, and controlling graphics in which the tray is opened or closed in the second apparatus when the button provided in the first apparatus is operated.

A recording medium according to still another embodiment of the invention records a program readable by a computer which executes processing including the steps of controlling a GUI for operating a first apparatus including buttons operated when opening and closing a tray, performing processing by receiving an instruction from the first apparatus, or transmitting the instruction to the first apparatus, including graphics of a second apparatus obtained by copying out the first apparatus in the GUI, and including graphics corresponding to the tray and the button in the second apparatus, controlling graphics in which the tray is opened or closed in the second apparatus when the button of the second apparatus is operated, and controlling graphics in which the tray is opened or closed in second apparatus when the button provided in the first apparatus is operated.

In the information processing apparatus, the method, the program and the storage medium thereof according to the embodiments of the invention, the display of the GUI for operation of the actual apparatus is controlled. When the actual apparatus is operated, graphics corresponding to the operation is performed on the GUI, and when the GUI is operated, the operation is reflected to the actual apparatus.

According to the embodiments of the invention, it is possible to save the trouble when performing verification of data.

### BRIEF DESCRIPTION OF THE DRAWINGS

FIG. 1 is a diagram showing a configuration of an example of an emulator in related art;

FIG. 2 is a view showing an example of an operation screen;

FIG. 3 is a view showing a configuration of a system to which the invention is applied;

FIG. 4 is a view showing a configuration example another system;

FIG. 5 is a view showing a configuration example another system;

FIG. 6 is a view showing a configuration example another system;

FIG. 7 is a diagram showing an internal configuration example of an emulator;

FIG. 8 is a diagram showing an internal configuration example of an operation terminal;

FIG. 9 is a diagram showing functions of the operation terminal;

FIG. 10 is a view showing a screen example;

FIG. 11 is a view showing a screen example;

FIG. 12 is a view showing a screen example;

FIG. 13 is a view showing a screen example;

FIG. 14 is a flowchart explaining operations of the operation terminal;

FIG. 15 is a view for explaining a registration method;

FIG. 16 is a flowchart explaining operations of the operation terminal;

FIG. 17 is a view showing a screen example;

FIG. 18 is a flowchart explaining operations of the operation terminal; and

FIG. 19 is a view showing a screen example.

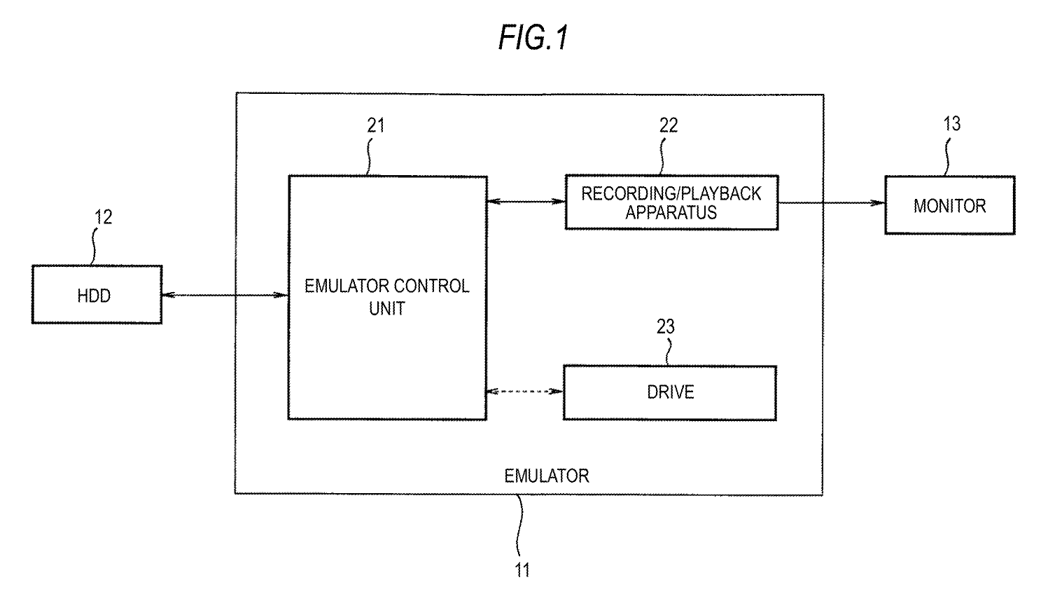

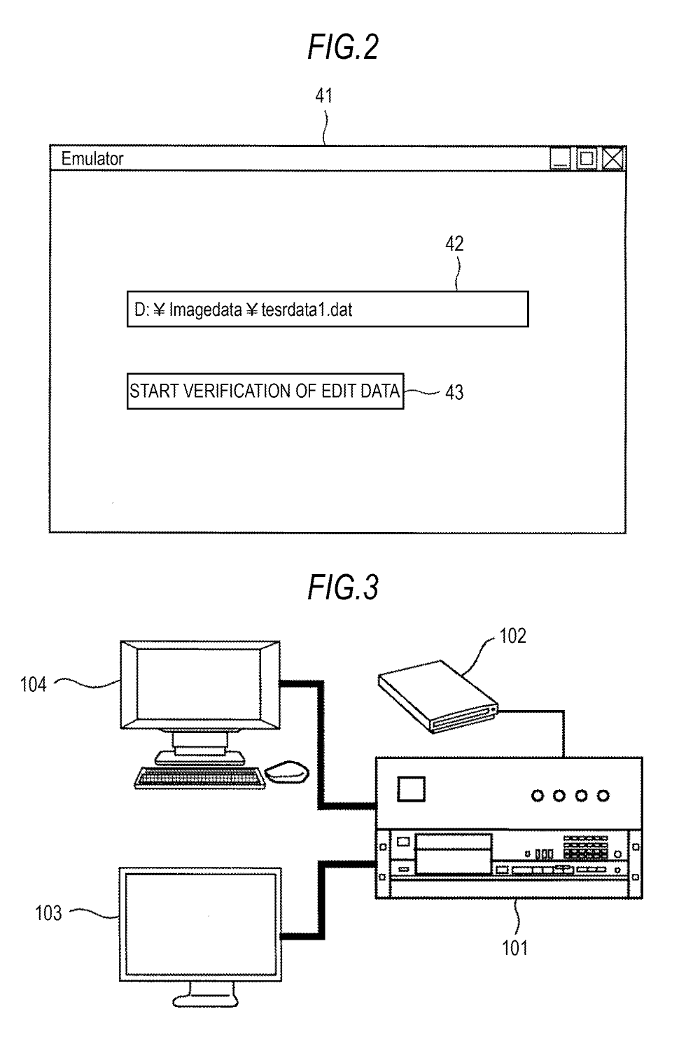

### DESCRIPTION OF THE PREFERRED EMBODIMENTS

Hereinafter, embodiments of the invention will be explained with reference to the drawings.

FIG. 3 is a view showing a configuration of a system to which the invention is applied. The system shown in FIG. 3 includes an edit data evaluation apparatus (hereinafter, written as an emulator) which is capable of verifying operations of edit data to be recorded in a BD-ROM (BD-Read Only Memory) used in recent years as a disc in which a blue-violet laser diode (hereinafter, written as “BD”) of 405 nm is used as a light source and which can record large volumes of video, music, character data and the like in forms of various discs.

The emulator is an apparatus which emulates actual reading conditions and the like of a disc by a disc drive. The emulator is used in authoring, which is a test tool used in an authoring studio for checking whether data is operated correctly in a player or a recorder (hereinafter, written as a recording/playback apparatus) at a point before actually making the disc when the contents of the disc such as the BD-ROM are created.

Specifically, the emulator is an apparatus in which a recording medium such as a hard disc drive (hereinafter, written as “HDD”) and a file server is connected instead of using a disc drive as a recording/playback apparatus, and disc image data of the BD-ROM on the HDD is recorded and played back as if the recording/playback apparatus read the BD-ROM.

The actual recording/playback apparatus accesses the disc, however, the emulator is adapted to access data recorded in the HDD instead of accessing the disc. According to the emulator adapted as described above, it is possible to verify operations such as a transfer rate, access time and the like which is edited data.

In the system shown in FIG. 3, an HDD 102 is connected to an emulator 101. For the connection, for example, a USB (Universal Serial Bus) is used. A monitor 103 which displays video played back by the emulator 101 and an operation terminal 104 which operates the emulator 101 are connected to the emulator 101. Additionally, a speaker which outputs audio played back by the emulator 101 is also connected to the emulator 101, though not shown.

In the example shown in FIG. 3, disc image data stored in the HDD 12 is supplied to the emulator 101 and played back, then, video is displayed on the monitor 103. The disc image data played back by the emulator 101 is disc image data specified based on an instruction by the operation terminal 104.

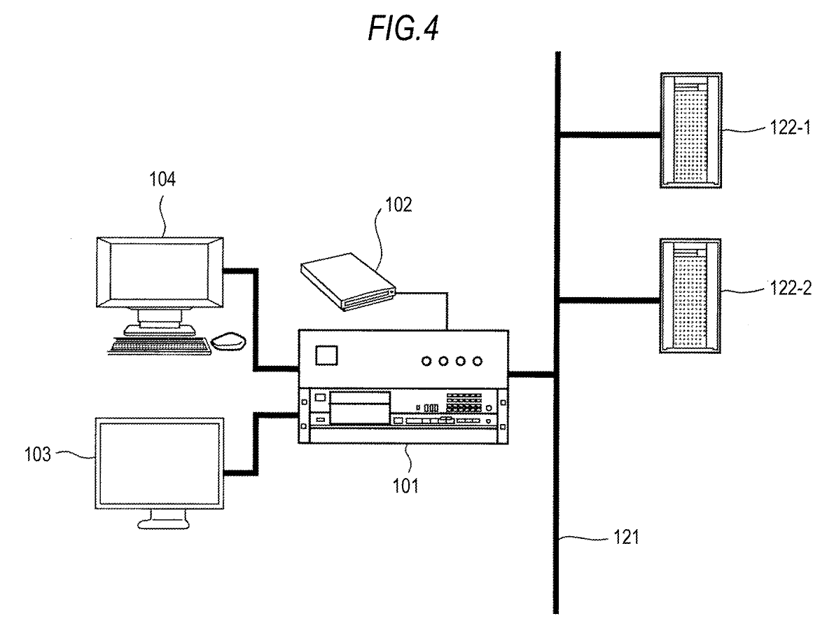

The example shown in FIG. 3 is a stand-alone type, however, it is also preferable to apply a form in which other file servers are combined as shown in FIG. 4. In a system shown in FIG. 4, a network 121 is added to the system shown in FIG. 3, and a file server 122-1 and a file server 122-2 are connected to the network 121.

The network 121 is formed by LAN (Local Area Network), which can apply both wired and wireless configurations. Furthermore, the network can include Internet and the like.

The emulator 101 is connected to the network 121, which is capable of giving and receiving data with respect to the file server 122-1 and the file server 122-2. The file server 122-1 and the file server 122-2 store disc image data. The emulator 101 can read disc image data stored in the HDD 102 and disc image data stored in the file server 122-1 and the file server 122-2 and can play back them.

The operation terminal 104 searches and specifies disc image data whose operations should be verified by the emulator 101 stored in any of the HDD 102, the file server 122-1 and the file server 122-2, instructing the emulator 101 to play back the data. The processing of searching disc image data can be performed easily by the user as described later.

In the following explanation, in the case that it is not necessary to discriminate the file server 122-1 from the file server 122-2 individually, it is simply written as a file server 122. Other components are also written in the same manner.

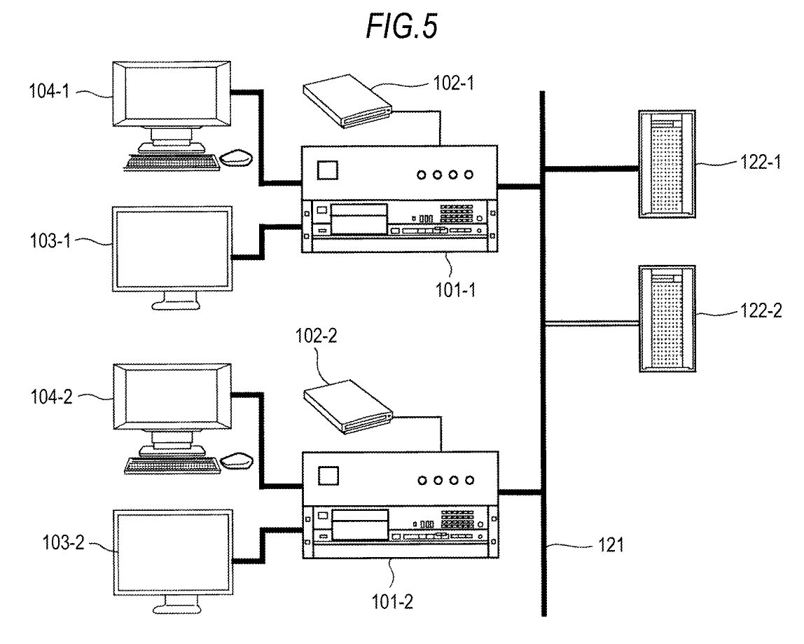

There is a case in which plural emulators 101 are connected to the network 121. A configuration example of a system in which plural emulators 101 are provided is shown in FIG. 5. An emulator 101-1 and an emulator 101-2 are connected to the network 121. An HDD 102-1 is connected to the emulator 101-1. Additionally, a monitor 103-1 displaying video played back by the emulator 101-1 and an operation terminal 104-1 operating the emulator 101-1 are connected to the emulator 101-1.

Similarly, an HDD 102-2 is connected to the emulator 101-2. Additionally, a monitor 103-2 displaying video played back by the emulator 101-2 and an operation terminal 104-2 operating the emulator 101-2 is connected to the emulator 101-2.

The file server 122-1 and the file server 122-2 are also connected to the network 121.

In the case of the system shown in FIG. 5, the operation terminal 104-1 is used for operating the emulator 101-1 and the operation terminal 104-2 is used for operating the emulator 101-2. That is, in this case, each emulator 101 is operated by the dedicated operation terminal 104.

The emulator 101-1 can play back disc image data stored in the HDD 102-1, the file server 122-1 and the like server 122-2 respectively. Similarly, the emulator 101-2 can play back disc image data stored in the HDD 102-2, the file server 122-1 and the file server 122-2 respectively.

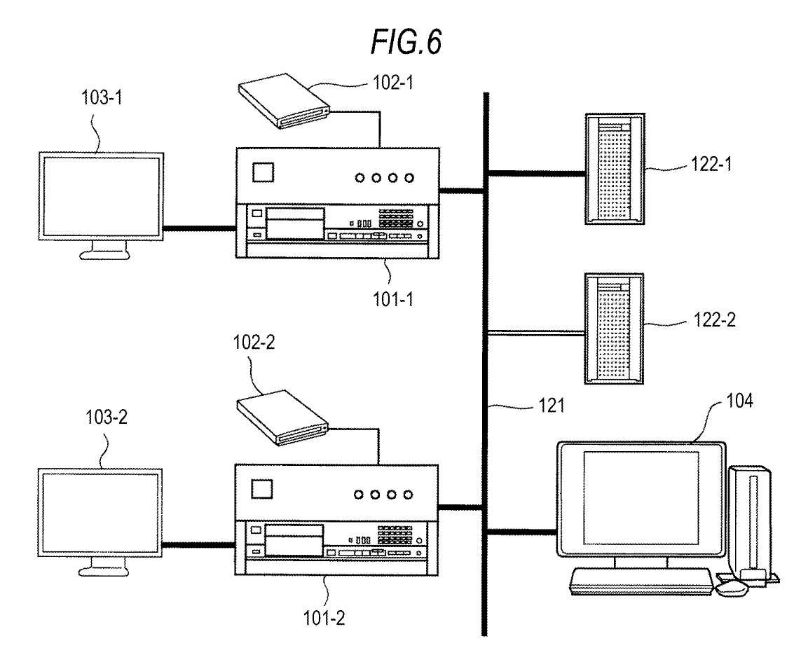

In the example shown in FIG. 5, each emulator 101 is operated by the dedicated operation terminal 104, however, it is also possible to apply a configuration in which plural emulators 101 are operated by one operation terminal 104. FIG. 6 is a view showing a configuration example of a system when plural emulators 101 are operated by one operation terminal 104.

The emulator 101-1, the emulator 101-2, the operation terminal 104, the file server 122-1 and the file server 122-2 are connected to the network 121. The HDD 102-1 and the monitor 103-1 are connected to the emulator 101-1. Similarly, the HDD 102-2 and the monitor 103-2 are connected to the emulator 101-2.

In the case, the operation terminal 104 operates the emulator 101-1 and the emulator 101-2. According to the configuration shown in FIG. 6, it is possible to perform verification of checking operations by allowing the emulator 101-1 and the emulator 101-2 to play back different disc image data respectively by one operation terminal 104.

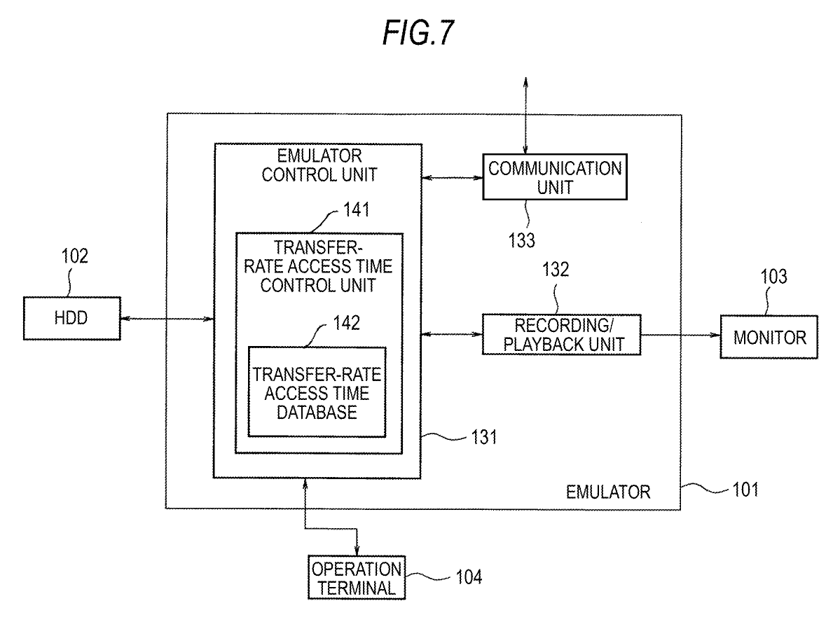

Next, a configuration of the emulator 101 shown in FIG. 3 to FIG. 6 will be explained. FIG. 7 is a diagram showing an internal configuration example of the emulator 101. The emulator 101 includes an emulator control unit 131, a recording/playback apparatus 132 and a communication unit 133. The emulator control unit 131 includes a transfer-rate access time control unit 141 and a transfer-rate access time database 142.

The recording/playback apparatus 132 included in the emulator 101 is actually made based on a player which is a commercially available electronic apparatus. For example, a commercially available BD-ROM player accesses an optical disc drive through ATAPI (interface of mutual devices between AT/PC)/ATA (connection standard for AT mutual devices) IF (interface), reading data from the optical disc and plays back the data. The emulator 101 has a configuration in which the emulator control unit 131 and the recording/playback apparatus 132 are connected through the same ATAPI/ATA IF.

In the emulator 101, the recording/playback apparatus 132 accesses the HDD 102 instead of accessing the drive, that is, the apparatus accesses disc image data in the HDD 102 as if it accessed the actual optical disc. According to the configuration, there are advantages such that all operations of the commercially available player can be verified in an actual apparatus and that operations can be verified when different kinds of players are connected.

The transfer-rate access time control unit 141 included in the emulator 101 controls the transfer rate to be an arbitrary value when transferring disc image data stored in the HDD 102 to the recording/playback apparatus 132 so as to perform control of delaying access time generated when an optical pickup moves to an arbitrary reading position at the time of actual access to the optical disc.

For example, the transfer-rate access time control unit 141 calculates delay time based on the difference between a logical block number of disc image data which is currently read and a logical block number which will be read next, and transfers the delay time to the recording/playback apparatus 132. The transfer-rate access time database 142 stores conditions such as the transfer rate and access time, and the transfer-rate access time control unit 141 performs control by using the stored information.

The communication unit 133 performs control of giving and receiving of data through the network 121 such as control at the time of acquiring disc image data from the file server 122 through the network 121.

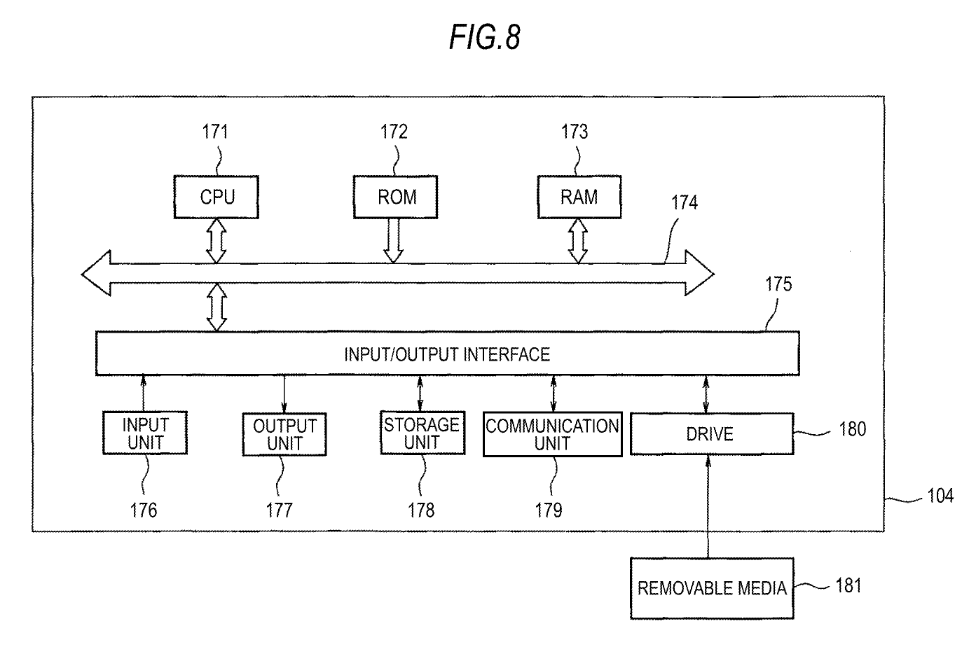

The operation terminal 104 can be formed by a personal computer. FIG. 8 is a view showing a configuration example when the operation terminal 104 is formed by a personal computer. In the operation terminal 104, a CPU (Central Processing Unit) 171, a ROM (Read Only Memory) 172, a RAM (Random Access Memory) 173 are mutually connected by a bus 174.

An input/output interface 175 is further connected to the bus 174. To the input/output interface 175, an input unit 176 including a keyboard, a mouse, a microphone and the like, an output unit 177 including a display, a speaker and the like, a storage unit 178 including a hard disc, a non-volatile memory and the like, a communication unit 179 including a network interface and the like and a drive 180 which drives removable media 181 such as a magnetic disc, an optical disc, a magnetic optical disc or a semiconductor memory are connected.

In the computer configured as the above, the CPU 171 loads a program stored in, for example, the storage unit 178 to the RAM 173 through the input/output interface 175 and the bus 174 and executes the program, thereby performing processing such as creation of display images (graphics) and control of the display thereof which will be described later.

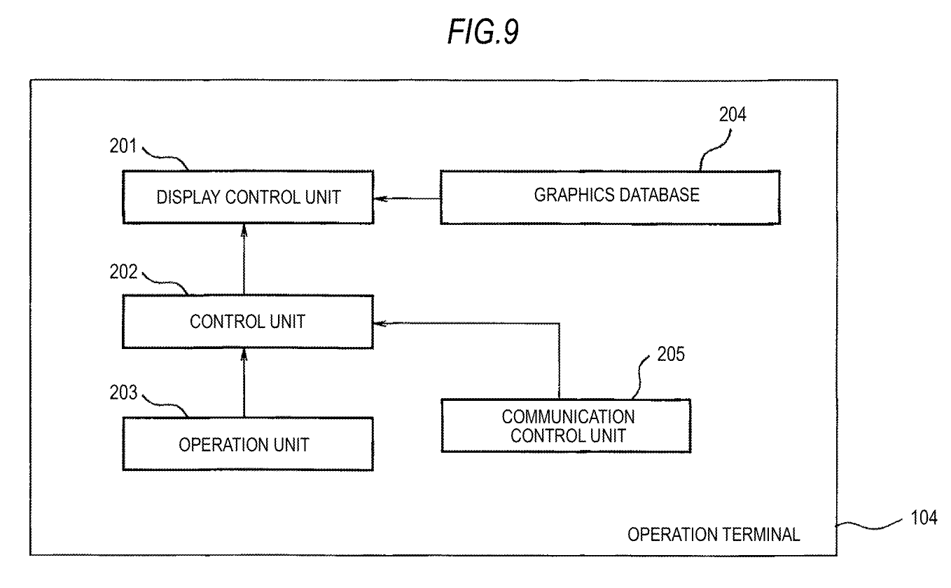

FIG. 9 is a functional block diagram showing functions of the operation terminal 104. The operation terminal includes a display control unit 201, a control unit 202, an operation unit 203, a graphics database 204 and a communication control unit 205.

The display control unit 201 creates a screen of a later-described GUI (graphical user interface) and controls display on the display. Data at the time of creating the screen of the graphics and the like by the display control unit 201 is stored in the graphics database 204. The screens to be created is, for example, screens corresponding to a case in which the operation unit 203 is operated, a case in which an instruction is supplied from another apparatus by control of the communication control unit 205 and the like.

The operation unit 203 corresponds to the input unit 176 shown in FIG. 8, including the keyboard, the mouse and the like, which is a function of receiving instructions from the user. The operation unit 203 also includes the GUI. The communication control unit 205 corresponds to the communication unit 179 shown in FIG. 8, acquiring disc image data from the file server 122 through the network 121. In the case of the system shown in FIG. 6, the communication control unit 205 transmits an instruction to the emulator 101 and acquires data from the emulator 101.

The screen displayed on the display of the operation terminal 104 by the operation terminal 104 having the above configuration will be explained as follows.

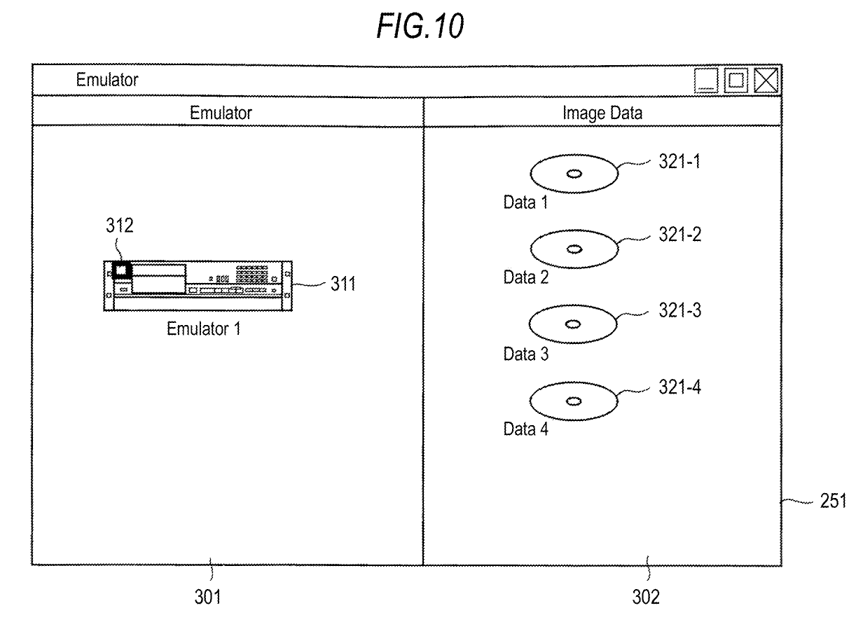

FIG. 10 is a view showing an example of a screen displayed on a display 251 by control of the display control unit 210. In the screen shown in FIG. 10, a screen 301 in which a picture 311 obtained by copying out the emulator 101 (hereinafter, written as an emulator picture 311) is displayed is provided on the left side in the drawing, and a screen 302 in which pictures 321 obtained by copying out discs (hereinafter, written as disc pictures 321) are displayed is provided on the right side in the drawing.

The emulator picture 311 displayed on the screen 301 indicates the emulator 101 to be operated by the operation terminal 104. For example, in the case of the system shown in FIG. 3, the emulator 101 which is directly connected to the operation terminal 104 is an operation target, therefore, the picture obtained by copying out the emulator 101 is displayed.

In the emulator picture 311, a button 312 for instructing open and close of a tray is provided, which is configured to be operated. That is, when the user operates the mouse and the like to allow a cursor (not shown) on the button 312 and performs a prescribed operation such as a click, graphics of in which the tray is opened or closed is displayed (which will be described later).

The disc pictures 321-1 to 321-4 obtained by copying out plural discs which are displayed on the screen 302 represent disc image data, respectively. For example, in the case of the system shown in FIG. 3, pictures represent disc image data stored in the HDD 102. The screen example shown in FIG. 10 represents a state in which four disc image data is stored in the HDD 102 and the disc pictures 321 respectively representing disc image data are displayed.

When the disc picture 321 described above is dragged and dropped onto, for example, the emulator picture 311, disc image data associated with the operated emulator picture 311 is played back in the actual emulator 101. In order to make the processing possible, it is necessary to associate the disc picture 321 with disc image data in advance. To associate means that an address (path) in which disc image data is stored is set to the disc picture 321.

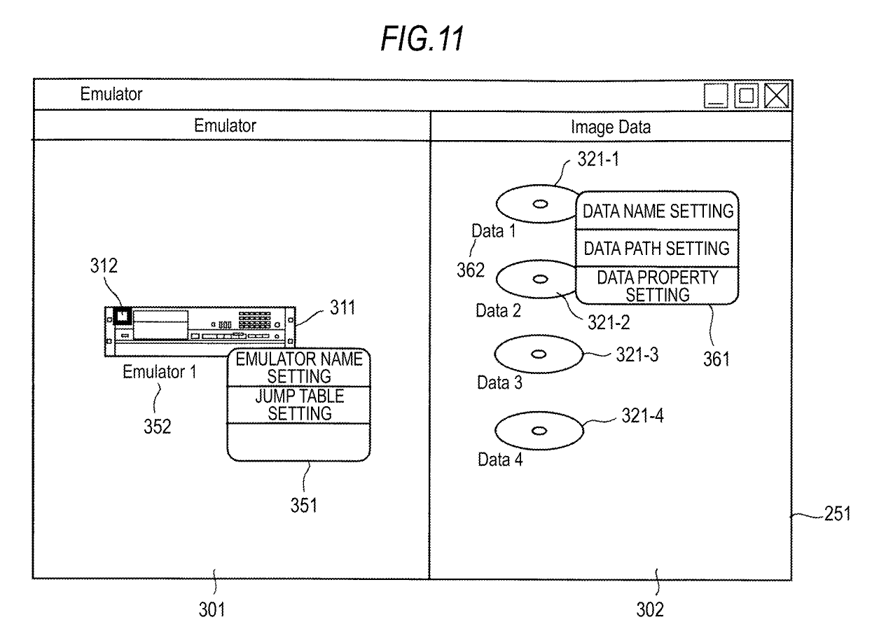

A screen example at the time of performing setting is shown in FIG. 11. The screen example shown in FIG. 11 shows both a screen at the time of setting given information to the emulator picture 311 and a screen at the time of setting given information to the disc picture 321. First, the case in which given information is set to the emulator 311 will be explained.

For example, when a given operation, for example, a right click of the mouse is performed in a state in which a cursor (not shown) is positioned on the emulator picture 311, a setting menu screen 351 is displayed. In the setting menu screen 351, an item “Emulator name setting” and an item “Jump table setting” are provided.

When the item “Emulator name setting” is operated, a name can be given to the emulator 101, and when the item “Jump table setting” is operated, a jump table can be set.

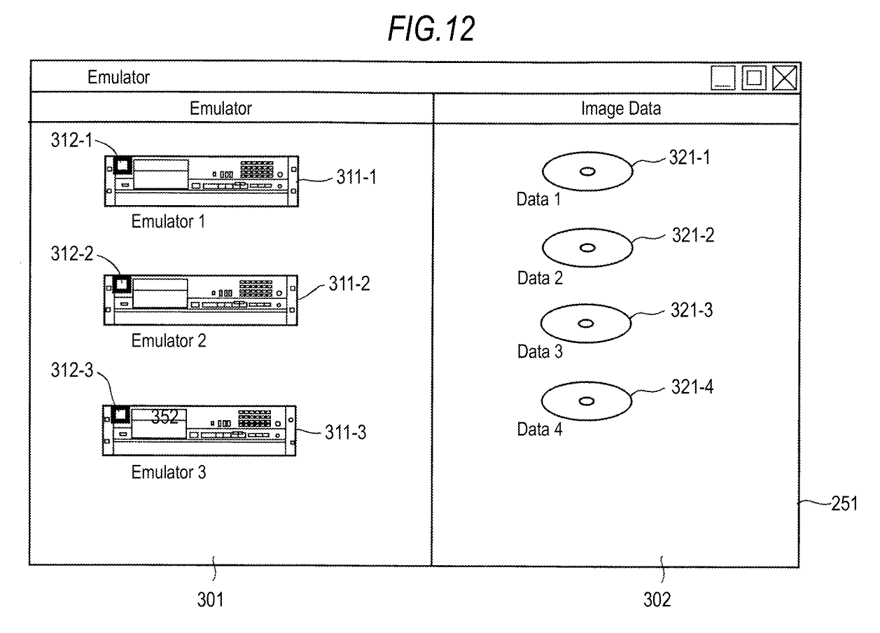

The reason that the item “Emulator name setting” is provided is for allowing the emulator picture 311 which is associated with the emulator 101 of the actual apparatus connected to the network 121 to be easily recognized in the case of the system shown in FIG. 6, that is, the case in which plural emulators 101 are connected to the network 121 and these emulators 101 are operated by one operation terminal 104. The screen displayed on the display in the case of system shown in FIG. 6 will be described with respect to FIG. 12.

When the item “Emulator name setting” is operated and a name is set to the emulator 101 registered in the emulator picture 311, the name is shown, for example, in an area 352 as shown in FIG. 11. The area 352 is provided in the vicinity (lower side in FIG. 11) of the emulator picture 311, and the set name is displayed in the area 352. In FIG. 11, an example in which a name “Emulator 1” has been set is shown. It is also preferable that the name such as “Emulator 1” is set as a name displayed as a default, in other words, as a name displayed in a case in which a name is not set by the user.

In the screen example shown in FIG. 11, when a given operation, for example, the operation of the right click of the mouse is performed in a state in which the cursor (not shown) is positioned on the disc picture 321 displayed on the display 302, a setting menu screen 361 is displayed. In the setting menu screen 361, an item “Data name setting”, an item “Data path setting” and an item “Data property setting” are provided.

When the item “Data name setting” is operated, a name with respect to disc image data assigned to the disc picture 321 can be set. When the item “Data path setting” is operated, a path (address) in which disc imaged data to be assigned to the disc picture 321 is stored can be set. When the item “Data property setting” is operated, property of set disc image data, for example, information indicating that data is in the first layer of the disc or that data is in the second layer can be set.

When the item “Data name setting” is operated and a name with respect to disc image data assigned to the disc picture 321 is set, the name is displayed, for example, in an area 362 as shown in FIG. 11. The area 362 is provided in the vicinity of (lower side in FIG. 11) of the disc picture 321, and the set name is displayed in the area 362. In FIG. 11, an example in which a name “Data 1” has been set is shown. It is also preferable that the name such as “Data 1” is set as a name displayed as a default, in other words, as a name displayed in a case in which a name is not set by the user.

When the item “Data path setting” is operated, a path (address) in which disc image data associated with the disc picture 321 is recorded can be set. The disc image data is data stored in the HDD 102 or the file server 122, and one data of data stored in the HDD 102 and the file server 122 can be specified in this setting, which can be associated with the disc picture 321.

When the disc picture 321 is associated with disc image data by setting the data path, it is possible to play back associated disc image data by the emulator 101 of the actual apparatus only by dragging and dropping the disc picture 321 onto the emulator picture 311 by the user.

The user can play back disc image data by the emulator 101 only by the above simple operation.

In the screen example shown in FIG. 11, the four disc pictures 321-1 to 321-4 are set. It is also preferable that the four disc pictures 321 are made to be displayed as a default as shown in FIG. 11 and disc image data is registered in respective disc pictures 321. In this case, the disc picture 321 in which disc image data is not registered is also displayed, however, it is possible to discriminate each disc image data by the disc name and the like given by the user. It is further preferable that the disc picture 321 can be added when the user desires to register more than four disc image data.

It is also preferable that the disc picture 321 is displayed when the disc image data is registered. For example, in the above embodiment, the setting menu screen 361 is displayed when a given operation is performed in the state in which the cursor (not shown) is positioned on the disc picture 321, however, it is also preferable that the setting menu screen 361 is displayed when the given operation is performed in a state in which the cursor is positioned at an area where the disc pictures 321 are not displayed in the screen 302. When the data path is set while the setting menu screen 361 is displayed, namely, when disc image data is registered, a disc picture 321 may be newly created and displayed. In this case, disc pictures 321 corresponding to the number of registered disc image data are displayed.

Next, the screen displayed on the display 251 in the case in which plural emulators 101 are connected to the network 121 and these emulators 101 are operated by one operation terminal 104 will be explained with reference to FIG. 12.

In the screen example shown in FIG. 12, plural emulator pictures 311 are displayed in the screen 301. In the example shown in FIG. 12, three emulator pictures 311-1 to 311-3 are displayed. For example, the emulator picture 311-1 corresponds to the emulator 101-1 of FIG. 6, the emulator picture 311-2 corresponds to the emulator 101-2 of FIG. 6 and the emulator picture 311-3 corresponds to an emulator 101-3 which is not shown in FIG. 6. In this case, three emulators are connected to the network 121.

In respective emulator pictures 311-1 to 311-3, buttons 312-1 to 312-3 operated when opening and closing trays are displayed respectively.

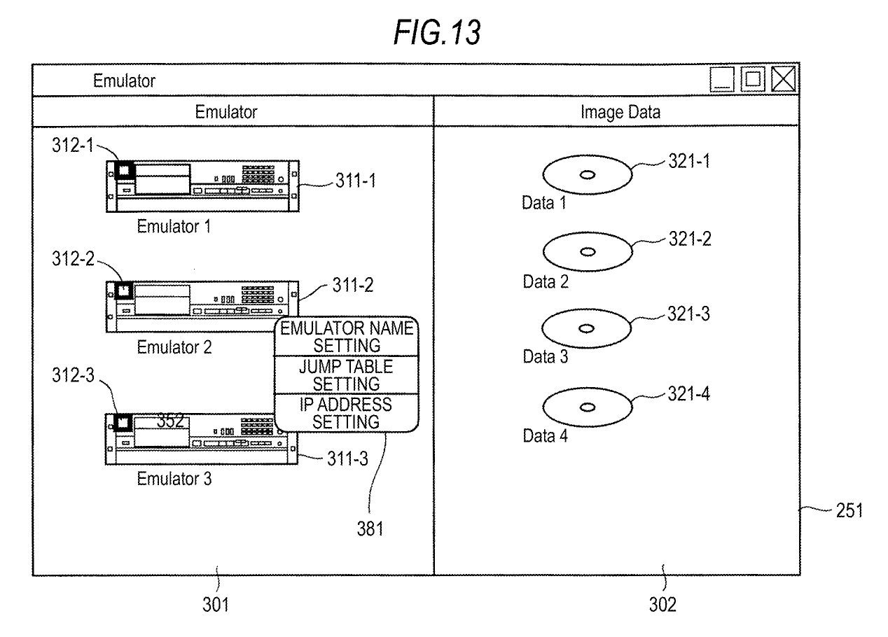

When the setting menu screen for setting the emulator name and the like is opened while plural emulator pictures 311-1 to 311-3 are displayed as the above, the screen as shown in FIG. 13 is displayed. In the screen example shown in FIG. 13, a setting menu screen 381 is displayed at the emulator picture 311-2. In the displayed setting menu screen 381, an item “Emulator name setting”, an item “Jump table setting” and an item “IP address setting” are provided.

When comparing items displayed in the setting menu screen 381 with items displayed in the setting menu screen 351 shown in FIG. 11, the setting menu screen 381 is different from the setting screen 351 in a point that the item “IP address setting” is provided in the setting menu screen 381 in addition to two items displayed in the setting menu screen 351. In the case that plural emulator pictures 311 are displayed, plural emulators 101 are registered. When one emulator 101 is specified from these registered plural emulators 101, an IP address is used as information for specifying the emulator 101.

In order to set information for identifying the emulator 101 by the user, the item “IP address setting” is provided in the setting menu screen 381 shown in FIG. 13.

It is also preferable that the item “IP address setting” is displayed also, for example, on the setting menu screen 351 in the case of the screen example shown in FIG. 11. That is, an IP address of the emulator 101 may be set and changed by the user even when only one emulator 101 is registered, and the IP address may be assigned by the user.

It is also preferable that the setting menu screen 381 is displayed when the user performs the operation of newly adding the emulator 101. For example, it is preferable that, when a given operation is performed in the state in which the cursor is positioned in the screen 301, the setting menu screen 381 is displayed and the name of the emulator and the jump table are set as well as the IP address is set.

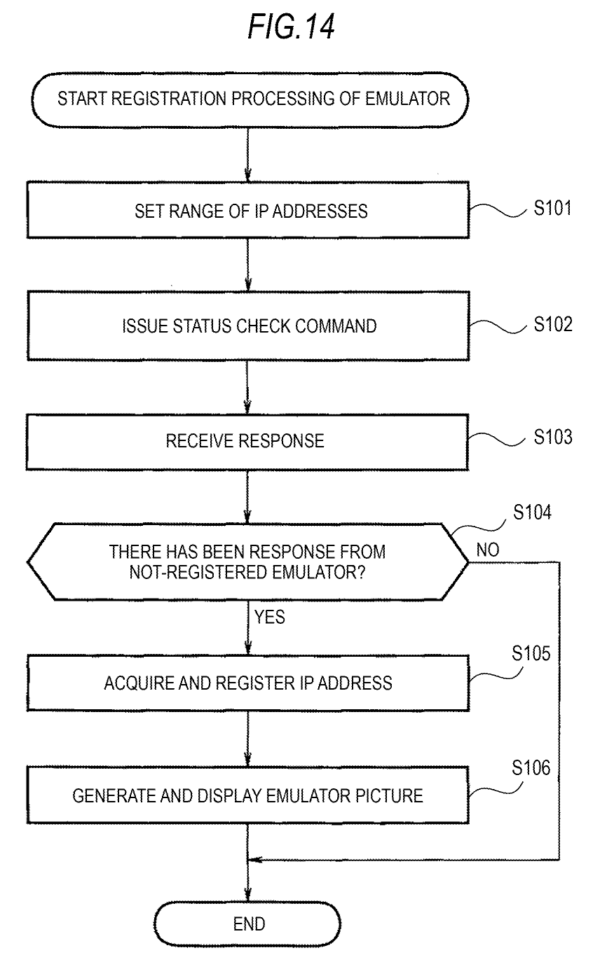

In this case, the IP address is set by the user, however, it is also preferable that the operation terminal 104 detects the emulator 101 newly connected to the network 121 and the emulator picture 311 is generated and displayed without troubling the user (automatically). Operations of the operation terminal 104 when applying the method will be explained with reference to a flowchart of FIG. 14.

In Step S101, the operation terminal 104 sets the range of IP addresses assigned to the emulators 101. For example, IP: 1 to 100 is set as IP addresses which can be assigned to the emulators 101. The processing in Step S101 can be performed when the operation of the operation terminal 104 is started, which is not constantly necessary to be performed when the following processing is executed. Therefore, the processing can be omitted when it have been performed once.

In Step S102, a status check command is issued. The operation terminal 104 generates the status check command at given intervals and generates the command to the terminal connected to the network 121. Each emulator 101 is configured to make a response when receiving the status check command.

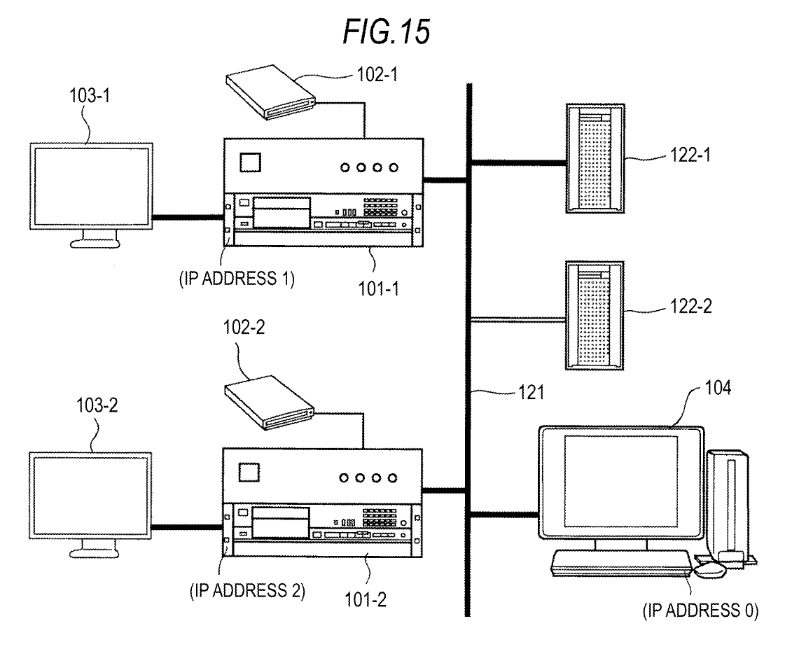

There is a case in which the emulator 101 which have been already registered is connected to the network 121 when the status check command is issued. In this case, a system as shown in FIG. 15 is constructed, and the emulator 101-1 and the emulator 101-2 have been already registered in the operation terminal 104. Additionally, as shown in FIG. 15, an IP address 1 is assigned to the emulator 101-1, an IP address 2 is assigned to the emulator 101-2 and an IP address “0” is assigned to the operation terminal 104.

In this case, the IP address “0”, the IP address 1 and the IP address 2 are registered in the operation terminal 104, and the fact that the IP address 1 indicates the emulator 101-1 and the IP address 2 indicates the emulator 101-2 is registered.

Under this state, when the status check command is issued from the operation terminal 104 in Step S102, responses from the emulator 101-1 and the emulator 101-2 are received in Step S103. If the new emulator 101 which is the emulator 101-3 is connected, a response from the emulator 101-3 is also received in Step S103. In Step S104, whether there has been a response from the newly-connected emulator 101 or not is determined.

In Step S104, whether there has been the response from the not-registered emulator 101 or not is determined. In the state shown in FIG. 15, the emulator 101-1 and the emulator 101-2 are already registered, therefore, when there have been responses only from the emulator 101-1 and the emulator 101-2, it is determined that there has not been any response from a not-registered emulator 101 in Step S104, and the registration processing of the emulator shown in FIG. 14 ends.

On the other hand, when the configuration is changed from the state as shown in FIG. 15 to the state in which the emulator 101-3 is newly connected to the network 121, responses from the emulator 101-1, the emulator 101-2 and the emulator 101-3 are received. Therefore, in this case, it is determined that there has been a response from the not-registered emulator 101-3 in Step S104, and the process proceeds to Step S105.

In Step S105, an IP address of the emulator 101 which is determined that it has been newly added, in this case, the emulator 101-3 is acquired and registered. Or, an IP address is assigned to the emulator 101 which is determined that it has been newly added and registered. Then, the emulator picture 311 associated with the registered IP address is generated, added and displayed on the screen 301 in Step S106. Accordingly, the emulator 101 newly connected to the network 211 is detected and registered.

When the emulator 101 is newly registered and the emulator picture 311 is newly displayed on the screen 301, a message indicating the registration and display to the user may be displayed. It is also preferable that the setting menu screen 351 or the setting menu screen 381 for setting the emulator name and the like is displayed at the newly-added emulator picture 311.

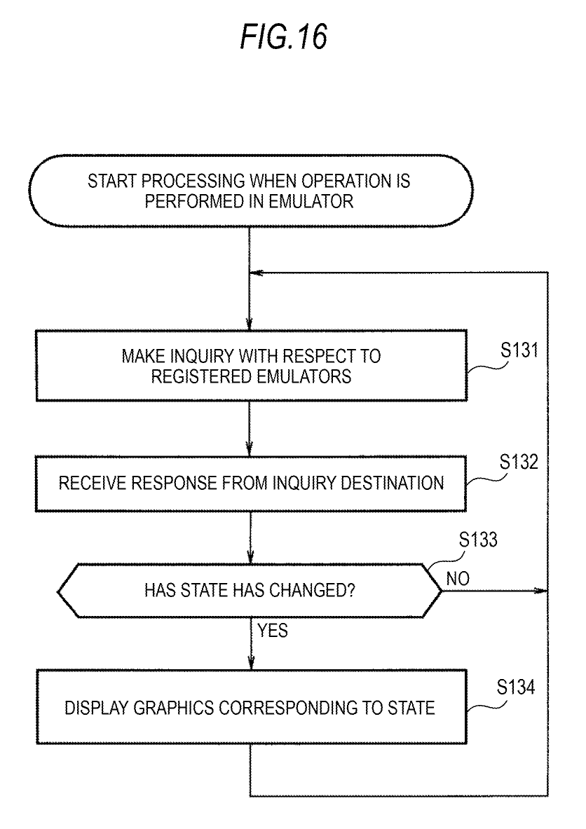

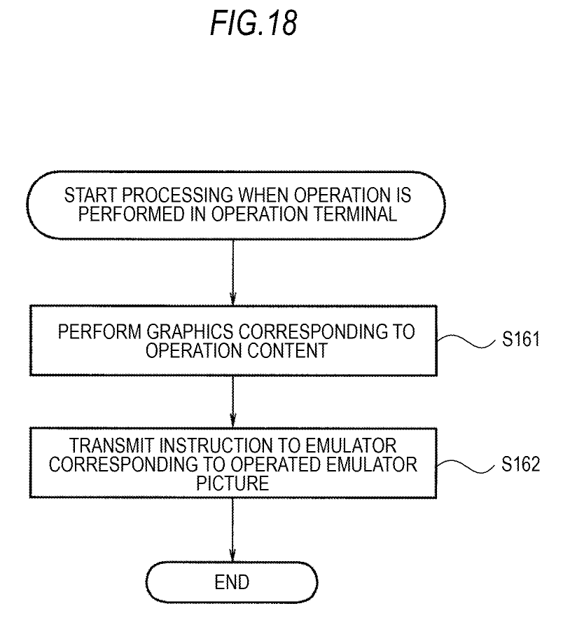

Next, operations in a state in which disc image data is already associated with the disc picture 321 after the emulator 101 is registered in the manner as described above will be explained. The processing in the operation terminal 104 when an operation is performed on the emulator 101 side will be explained with reference to FIG. 16. Further, the processing in the operation terminal 104 when an operation is performed on the operation terminal 104 side will be explained with reference to FIG. 18.

In Step S131 (FIG. 16), the control unit 202 of the operation terminal 104 inquires of the registered emulator 101 the state at that time, controlling the communication control unit 205 to execute the inquiry. When there are plural registered emulators 101, the inquiry is sequentially made. That is, the operation terminal 104 constantly checks the state of the emulator by performing polling.

For example, in the system configuration as shown in FIG. 4, inquiry is made with respect to the emulator 101 which is directly connected. In the system configuration as shown in FIG. 6, inquiry is made with respect to the emulator 101-1 and the emulator 101-2.

When the inquiry is made, a response is transmitted from the emulator 101. In Step S132, the communication control unit 205 of the operation terminal 104 receives a response from the emulator 101. The contents of the response indicate, for example, that an eject button has been operated, that a close button has been operated and that emulator is in a play state.

When the user operates buttons provided in the body of the emulator 101 or the remote controller for operating the emulator 101 (in the case of the emulator 101, the remote controller for the recording/playback apparatus 132), the operation content is given back to the operation terminal 104.

In Step S133, the control unit 202 analyzes the response from the emulator 101 received by the communication control unit 205, determining whether the state has changed or not. For example, when obtaining the analysis results indicating that the eject button has been operated, that the close button has been operated and the like, it is determined that the state has changed.

When it is determined that the state has changed in Step S133, the process proceeds to Step S134. In Step S134, the control unit 202 transmits graphics determined from the analysis results to the display control unit 201, and the display control unit 201 controls display of graphics corresponding to the state. The display control unit 201 reads data of the graphics corresponding to the state from the graphics database 204 and controls display to the display 251.

The above processing is performed repeatedly, thereby controlling graphics of the screen displayed on the display 251. Here, an example of the graphics is shown to make explanation thereof.

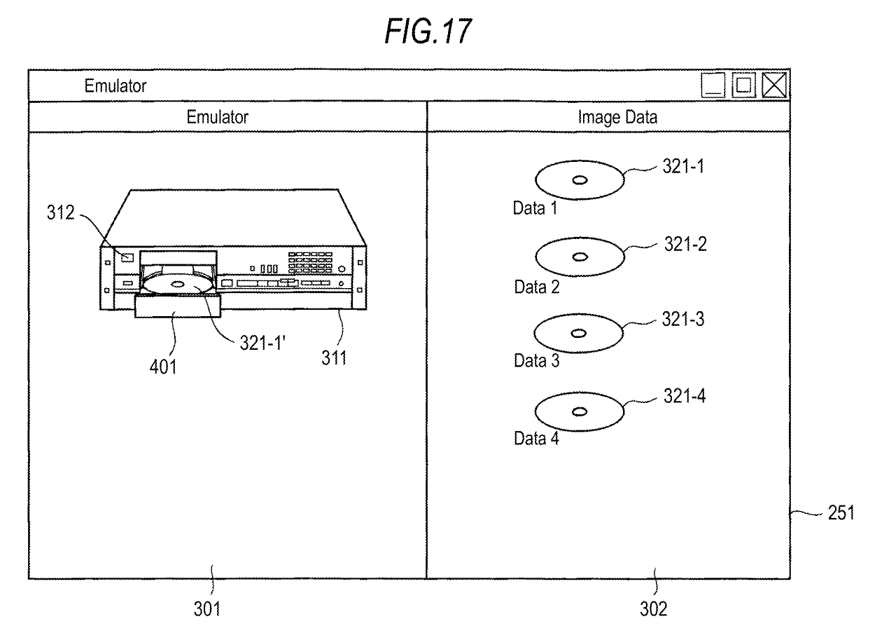

FIG. 17 is a screen example when the eject button provided in the body of the emulator 101 or the eject button of the remote controller (not shown) is operated. When the eject button is operated, a picture (graphics) representing a state in which a tray 401 of the emulator picture 311 is opened is displayed on the screen 301. At this time, when plural emulators 101 are connected to the network 121, the graphics indicating the state in which the tray 401 of the emulator picture 311 corresponding to the operated emulator 101 is opened is displayed.

After the emulator picture 311 becomes the picture representing the state in which the tray is opened, when the user drags the disc picture 321, for example, the disc picture 321-1, and drops the picture on the tray 401 in the open state, a disc picture 321-1′ is displayed as shown in FIG. 17. The display allows the user to recognize that the disc has been actually set in the emulator.

When the user operates the emulator 101 of the actual apparatus, graphics corresponding to the operation is expressed by the emulator picture 311 and the disc is also set on the tray, therefore, the user can deal with disc image data with the same feeling as when operating the emulator 101 of the actual apparatus.

The emulator 101 (the recording/playback apparatus 132 included in the emulator 101) plays back disc image data stored in the HDD 102 and the like. However, the actual recording/playback apparatus 132 includes a drive to which a disc is set, playing back the disc set in the drive. The user can check whether a disc is the disc desired to be played back or not, in other words, whether the disc is data desired to be played back or not by a behavior of setting the disc when operating the actual recording/playback apparatus 132. The user also recognizes that the disc has been certainly set by the behavior of setting the disc.

However, as described above, since the emulator 101 plays back disc image data stored in the HDD 102, there is no operation of setting the disc, and the user has no way of knowing whether the desired data has been selected or not and whether the desired data has been set correctly or not.

However, the graphics as if the emulator 101 of the actual apparatus were operated is performed in the emulator picture 311 displayed on the display 251 as described above, therefore, the user can check that the disc (disc image data) has been set to the emulator 101 correctly. Further, when disc image data is selected, the disc picture 321 obtained by copying out the disc is selected, therefore, it is possible to select the disc while checking whether it is the desired data or not in the same manner as the selection of the actual disc, as a result, it is possible to prevent the selection of wrong disc image data.

Accordingly, when a button of, for example, playback provided in the body of the emulator 101 of the actual apparatus or a button of playback provided in the remote controller is operated after the disc picture 321-1′ is set to the tray 401, playback of disc image data is started in the emulator 101.

Next, operations of the operation terminal 104 when an operation is performed with respect to the emulator picture 311 as the GUI will be explained with reference to a flowchart of FIG. 18.

In Step S161, the control unit 202 of the operation terminal 104 receives an instruction from the operation unit 203. Then, the control unit 202 instructs the display control unit 201 to perform graphics corresponding to the operation content. According to this, the graphics corresponding to the operation content is performed.

The control unit 202 of the operation terminal 104 generates a command corresponding to the operation content and transmits the generated command to the corresponding emulator 101 by controlling the communication control unit 205 in Step S162.

The processing of the flowchart shown in FIG. 18 will be specifically explained. The instruction from the user is received by the operation unit 203, and the operation content is supplied from the operation unit 203 to the control unit 202. The operation unit 203 includes the GUI. In this case, the GUI is, for example, the button 312 of the emulator picture 311 shown in FIG. 10.

When the button 312 of the emulator picture 311 is operated, the fact that the button 312 has been operated is supplied from the operation unit 203 to the control unit 202. The control unit 202 instructs the display control unit 201 to perform graphics by the operation of the button 312 after analyzing that the button 312 has been operated. Accordingly, graphics in which the tray 401 is closed is performed when the tray 401 is in the open state, and graphics in which the tray 401 is opened is performed when the tray 401 is in the closed state.

The display of graphics is controlled as well as a command is issued with respect to the emulator 101 corresponding to the operated emulator picture 311. For example, when the button 312 is operated, a command instructing open or close of the tray 401 is issued. However, the recording/playback apparatus 132 included in the emulator 101 is not provided with a drive (it is usually removed), therefore, the operation of opening and closing the tray is not performed on the emulator 101 side even when the command is issued. Therefore, to perform graphics indicating open and close of the tray 401 at the emulator picture 311 on the GUI is an effective means.

Another example will be explained. When the disc picture 321 is dragged and dropped on the emulator 101, a series of graphics in which the tray 401 is opened and the disc picture 321 is displayed in the opened tray 401 is performed. The state in which the series of graphics is performed is the state shown in FIG. 17. In this case, the user only performs a simple operation in which the disc picture 321 corresponding to disc image data desired to be played back is dragged and dropped onto the emulator picture 311, thereby performing graphics showing that the operation is performed. According to the graphics performed as described above, it is possible to allow the user to recognize that disc image data has been certainly selected and the emulator 101 becomes in a state of waiting an instruction of playback.

Then, the display of graphics is controlled as well as a command is issued to the emulator 101 corresponding to the operated emulator picture 311. When the playback instruction is performed by the user, the command to be issued is a command of instructing playback of disc image data.

It is also preferable that, when the disc picture 321 is dragged and dropped onto the emulator picture 311, a series of graphics indicating a state in which the tray 401 is opened and the disc picture 321 is set on the tray 401, and further the tray 401 is closed is performed. It is also preferable that the command instructing the emulator 101 to perform playback is issued and playback is started even when the user does not instruct the playback.

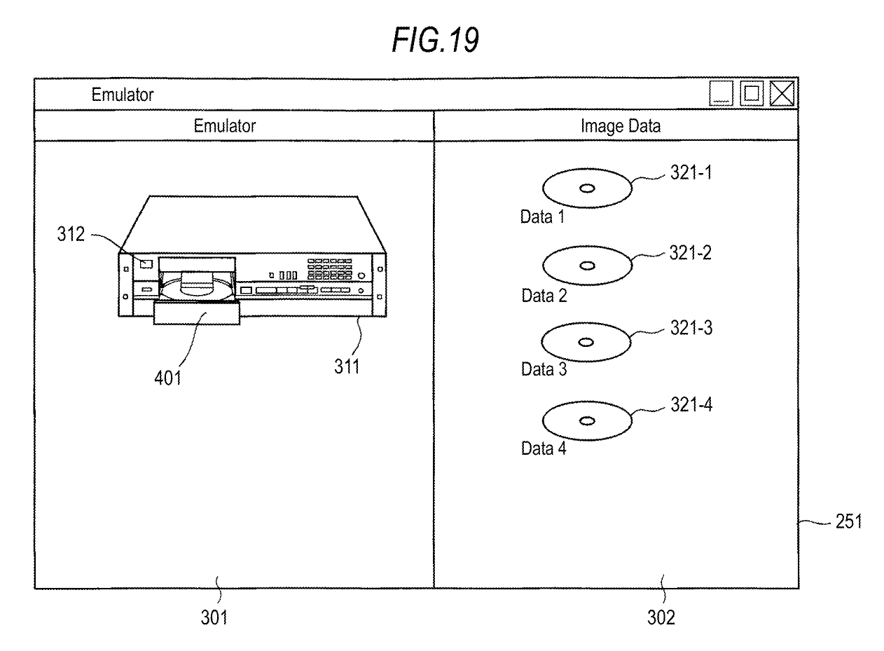

Further another example will be explained. In the emulator 101 of the actual apparatus (the recording/playback apparatus 132 included in the emulator 101), an operation of removing the disc from the tray is performed by the user when the playback is finished. Therefore, it is configured so that the operation is similarly performed also in the emulator picture 311. That is, when the user operates the button 312 of the emulator picture 311 in a state in which the disc is set, graphics indicating a state in which the tray 401 is opened is performed as shown in FIG. 19.

According to the graphics performed as the above, it is possible to allow the user to recognize that the disc is not set in the tray 401 as well as to recognize that a new disc can be set.

The display of graphics is controlled as well as a command is issued with respect to the emulator 101 corresponding to the operated emulator picture 311. In this case, the command to be issued is a command of stopping playback of disc image data.

When the button 312 of the emulator picture 311 is operated, graphics indicating open and close of the tray 401 is performed so as to correspond to the operation as described above. Also, when the disc picture is dragged and dropped onto the emulator picture 311, graphics indicating open and close of the tray 401 and graphics indicating a state in which the disc picture 321 is set on the tray 401 are performed.

As described above, according to the embodiment of the invention, information such as a file path (address), a file name and an attribute of disc image data to be edited is once set, thereby performing operations for verification in a state in which the user does not realize a place of data, that is, whether data is stored in the HDD 102 connected to the emulator 101 or in the file server 122 connected to the network 121. Accordingly, the operationality can be improved.

It is possible to perform operations for verification by using operation images when the actual disc is played by in the recording/playback apparatus, which improves usability for the user as well as improves operationality.

Also, when plural verification data (disc image data) is verified, the verification operation can be performed easily by performing a registration setting work once. That is, even when plural verification data is dealt with, operations for verification can be performed without complicated processing.

When the system configuration as shown in FIG. 6 is applied, plural emulators 101 can be set and operated at the same time from a place other than setting places thereof, and it is not necessary to provide plural operation terminals 104, as a result, space therefor can be saved. Accordingly, space efficiency for constructing the system is increased as well as concentrated operation, management and employment can be realized, as a result, efficient verification of editing data can be realized.

The above-described series of processing can be executed both by hardware and software. When the series of processing is executed by software, programs included in the software are installed from a program storage medium to a computer incorporated in dedicated hardware or, for example, a general-purpose personal computer which can execute various functions by installing various programs.

As a hardware configuration of the computer, for example, the configuration as shown in FIG. 8 can be cited. Programs executed by the computer (CPU 171) are provided by recording in removable media 181 which are packaged media including, for example, a magnetic disc (including a flexible disc), an optical disc (CD-ROM (Compact Disc-Read Only Memory), a DVD (Digital Versatile Disc) and the like), a magnetic-optical disc or a semiconductor memory or provided through wired or wireless transmission media such as a local area network, Internet and digital satellite broadcasting.

Programs can be installed in the storage unit 178 through the input/output interface 175 by mounting the removable media 181 on the drive 180. Programs also can be received by the communication unit 179 through wired or wireless transmission media and installed in the storage unit 178. In addition, programs can be installed in the ROM 172 or the storage unit 178 in advance.

The Program executed by the computer may be the program processed in time series along the order explained in the present specification or may be the program processed in parallel, or at necessary timing when called or at other occasions.

In the specification, the system indicates the whole apparatus including plural apparatuses.

The invention is not limited to the above embodiment but can be variously modified within a range not departing from the gist of the invention.

The present application contains subject matter related to that disclosed in Japanese Priority Patent Application JP 2008-151684 filed in the Japan Patent Office on Jun. 10, 2008, the entire contents of which are hereby incorporated by reference.

1. An information processing apparatus comprising:
a display control means for controlling display of a graphical user interface (GUI) for operating a first apparatus, the first apparatus including a button operated when opening and closing a tray of the first apparatus; and
a processing means for performing processing by receiving an instruction from the first apparatus or for transmitting the instruction to the first apparatus,
wherein the GUI includes graphics of a second apparatus obtained by copying out the first apparatus, and the graphics of the second apparatus include graphics corresponding to the tray and the button,
when the button in the graphics of the second apparatus is operated, the display control means controls the graphics of the second apparatus such that the tray is opened or closed in the graphics of the second apparatus, and
when the button provided in the first apparatus is operated, the processing means instructs the display control means to control the graphics of the second apparatus such that the tray is opened or closed in the graphics of the second apparatus.

2. The information processing apparatus according to claim 1,
wherein, when the first apparatus is a plurality of first apparatuses, the display control means controls the display so that a plurality of second apparatuses respectively corresponding to the plurality of first apparatuses are displayed in the GUI.

3. The information processing apparatus according to claim 1,
wherein a storage device is connected to the first apparatus, and disc image data is stored in the storage device,
wherein the GUI includes graphics obtained by copying out a disc associated with the disc image data, and
wherein, when the graphics obtained by copying out the disc are dragged and dropped onto the graphics of the second apparatus, the display control means controls the graphics of the second apparatus to change from a state in which the tray of the second apparatus is opened to a state in which the disc is set on the opened tray, and the processing means instructs the first apparatus to play back the disc image data associated wit the graphics obtained by copying out the disc which has been dragged and dropped.

4. The information processing apparatus according to claim 3,
wherein the storage device further comprises a storage device connected through a network.

5. The information processing apparatus according to claim 1,
wherein, when the first apparatus is newly connected to a network, the display control means generates graphics of the second apparatus corresponding to the first apparatus which has been newly connected and displays the generated graphics in the GUI.

6. An information processing method comprising the acts of:
controlling a GUI for operating a first apparatus, the first apparatus including a button operated when opening and closing a tray of the first apparatus,
performing processing by receiving an instruction from the first apparatus or transmitting the instruction to the first apparatus,
displaying graphics of a second apparatus, obtained by copying out the first apparatus, in the GUI, and including graphics corresponding to the tray and the button in the graphics of the second apparatus,
controlling the graphics of the second apparatus such that the tray is opened or closed in the graphics of the second apparatus when the button of the graphics of the second apparatus is operated, and
controlling the graphics of the second apparatus such that the tray is opened or closed in graphics of the second apparatus when the button provided in the first apparatus is operated.

7. A program readable by a computer which executes processing including the acts of:
controlling a GUI for operating a first apparatus, the first apparatus including a button operated when opening and closing a tray of the first apparatus,
performing processing by receiving an instruction from the first apparatus or transmitting the instruction to the first apparatus,
displaying graphics of a second apparatus, obtained by copying out the first apparatus, in the GUI, and including graphics corresponding to the tray and the button in the graphics of the second apparatus,
controlling the graphics of the second apparatus such that the tray is opened or closed in the graphics of the second apparatus when the button of the graphics of the second apparatus is operated, and
controlling the graphics of the second apparatus such that the tray is opened or closed in graphics of the second apparatus when the button provided in the first apparatus is operated.

8. A recording medium recording a program readable by a computer which executes processing including the acts of:
controlling a GUI for operating a first apparatus, the first apparatus including a button operated when opening and closing a tray of the first apparatus,
performing processing by receiving an instruction from the first apparatus or transmitting the instruction to the first apparatus,
displaying graphics of a second apparatus, obtained by copying out the first apparatus, in the GUI, and including graphics corresponding to the tray and the button in the graphics of the second apparatus,
controlling the graphics of the second apparatus such that the tray is opened or closed in the graphics of the second apparatus when the button of the graphics of the second apparatus is operated, and
controlling the graphics of the second apparatus such that the tray is opened or closed in graphics of the second apparatus when the button provided in the first apparatus is operated.

9. An information processing apparatus comprising:
a display control unit configured to control display of a GUI for operating a first apparatus, the first apparatus including a button operated when opening and closing a tray of the first apparatus; and
a processing unit configured to perform processing by receiving an instruction from the first apparatus or for transmitting the instruction to the first apparatus,
wherein the GUI includes graphics of a second apparatus obtained by copying out the first apparatus, and the graphics of the second apparatus include graphics corresponding to the tray and the button,
when the button in the graphics of the second apparatus is operated, the display control unit controls the graphics of the second apparatus such that the tray is opened or closed in the graphics of the second apparatus, and
when the button provided in the first apparatus is operated, the processing unit instructs the display control unit to control the graphics of the second apparatus such that the tray is opened or closed in the graphics of the second apparatus.
